(19) United States
(12) Patent Application Publication
(10) Pub. No.: US 2014/0025470 A1
(43) Pub. Date: Jan. 23, 2014

(54) METHOD AND SYSTEM FOR FACILITATING MERCHANT-CUSTOMER RETAIL EVENTS

(71) Applicants: Brett Aksel Berman, Westlake Village, CA (US); Timothy Edward Rothwell, II, Austin, TX (US)

(72) Inventors: Brett Aksel Berman, Westlake Village, CA (US); Timothy Edward Rothwell, II, Austin, TX (US)

(21) Appl. No.: 13/944,849

(22) Filed: Jul. 17, 2013

Related U.S. Application Data
(60) Provisional application No. 61/672,967, filed on Jul. 18, 2012.

(51) Int. Cl. G06Q 30/02

(52) U.S. Cl. CPC G06Q 30/0235; G06Q 30/0225
USPC 705/14.26

(57) ABSTRACT

Method and system is disclosed for facilitating merchant-customer retail events. The retailing system provides a service that simplifies the processes whereby consumers interact electronically with merchants, to pay for purchases, to receive relevant offers, and/or track receipts. A method for allowing a consumer to complete a payment transaction with a merchant is described. The method includes providing a redemption code to the user when the user is physically present within a preset area or distance to the merchant. In this way fraud and transaction quantity may be controlled.

### CROSS REFERENCE TO RELATED APPLICATIONS

This application claims the benefit of Provisional Application No. 61/672,967 filed on Jul. 18, 2012 which is hereby incorporated herein by reference.

### TECHNICAL FIELD

This disclosure relates to systems used to offer goods or services to consumers, and more particularly to location-based offering systems.

### BACKGROUND

The statements in this section merely provide background information related to the present disclosure and may not constitute prior art.

In today's marketplace, retail events, i.e., a sale of a good or services, or a purchase of a good or service, can occur virtually via an internet network, voice communication network, or in person at, for example, a brick-and-mortar location or through a combination. Generally, negotiation is absent between the merchant and consumer with respect to the terms of a sale or purchase of a good or service. Retailing characteristically employs a merchant-controlled format whereby the merchant determines which goods or services to offer for sale, when the goods or services will be offered for sale, and the non-negotiable fixed price at which the good or service will be sold.

Discounting goods and services are an integral part of retail strategies for many businesses. Merchants may rely upon discounts to promote new and existing goods and services, to increase the sales of particular items or services. In many cases, a merchant offers coupons or rebates in the hopes of securing future sales at full retail prices, repeat sales and ultimately an increase in overall sales. Ultimately, merchants cannot offer goods and services at a discount unless the merchant can ensure a minimum number of sales to justify the discount. Discounting techniques can also include pricing curve group discount models, however traditional pricing curve group discount models confuse consumers and leave them feeling like they did not get the best possible deal.

Discounting techniques can include providing coupons and rebates to potential customers. These techniques have several disadvantages, including small consumer participation percentage and fraud. Since the participation level is generally small, merchants utilize consumer identification techniques such canvasing or demographic associations of potential customers. Nevertheless, most of the coupons or rebates are delivered to consumers that do not need or desire the goods or services. Coupons and rebates have historically been distributed using print mediums such as direct mail, newspaper print, and magazines. Recently, the internet, electronic mail, and internet search engine sites have allowed merchants to more effectively and inexpensively target potential customers.

More recently, merchants have utilized offer programs of third parties to identify potential customers and offer discounts. Group discount programs, can be a type of marketing or advertising for merchants allowing them to reach consumers that might not otherwise visit the merchant. The most notable example of group offer programs is works as an assurance contract using its web platform. Known group discount programs by facilitating companies enable a merchant to control a contingent offer based on the number of potential customers that accept the deal, and in which the deal only becomes valid if a certain number of customers accept the offer. If the predetermined minimum is not met, no one gets the offer. This reduces risk for merchants, who can treat the offers/coupons as quantity discounts, as well as sales promotion tools. The company makes money by keeping approximately half the money the consumer pays for the coupon. So, for example, a $100 ticket could be purchased by the consumer for $50 and then the facilitating company and the merchant would split the $50.

That is, the merchant provides a ticket valued at $100 and gets approximately $25 from the facilitating company in exchange. The consumer gets the ticket, in this example, from the retailer for which they have paid $50 to the facilitating company. Unlike classified advertising, the merchant does not pay any upfront cost to participate; the facilitating company collects personal information from willing consumers and then contacts only those consumers, primarily by a daily email, who may possibly be interested in a particular product or service.

Facilitating companies and other known discount offering programs do not provide time-limited retail and business offers that are contingent on subscribing to a particular merchant's offers and a physical user location (as inferred by a mobile device). Further, known discounting systems do not limit access to discounting codes such as a QR code or bar scan codes associated with particular offers. By limiting access to discounting codes to consumers within certain definable geographical locations, a merchant can limit opportunities for discounting fraud and more effectively limit redemption periods. As will be understood from a careful reading of the disclosure herein, receiving discounting offers based on a geographic location and user selected merchants will enable a user to receive more useful discounts and thereby decreasing risk that potential customers will ignore the discounting offer or future discounting offers. Therefore, it would be beneficial to provide improved techniques for providing location-based, time-limited offers to people and computing devices subscribing to merchant-specific offers.

### SUMMARY

Method and system is disclosed for facilitating merchant-customer retail events. The retailing system provides a service that simplifies the processes whereby consumers interact electronically with merchants, to pay for purchases, to receive relevant offers, and/or track receipts. A method for allowing a consumer to complete a payment transaction with a merchant is described. The method includes providing a redemption code to the user when the user is physically present within a preset area or distance to the merchant. In this way fraud and transaction quantity may be controlled.

In an embodiment of the present disclosure, it is contemplated to provide a coupon campaign and a merchant offer campaign. The merchant offer campaign is delivered to subscribers of a particular merchant and/or system users within a predetermined distance or area associated with the merchant. The merchant offers are time-limited. The coupon campaigns include one or more coupons, preferably searchable, wherein information associated with the coupon is selectively communicated to a user upon satisfaction of a predetermined contingency such as payment.

In an alternative embodiment of the present disclosure, an incentive program or loyalty program is contemplated. The incentive program promotes or encourages specific actions or behavior of customers or consumers. According to the present disclosure, consumers collect and redeem points. Points are redeemed for one or more awards, such as goods services or other deals. It is contemplated that an award may be monetary or non-monetary.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows a retail system communicatively connected to an exemplary mobile device, in accordance with the present disclosure;

FIG. 2 shows an exemplary control scheme, in accordance with the present disclosure;

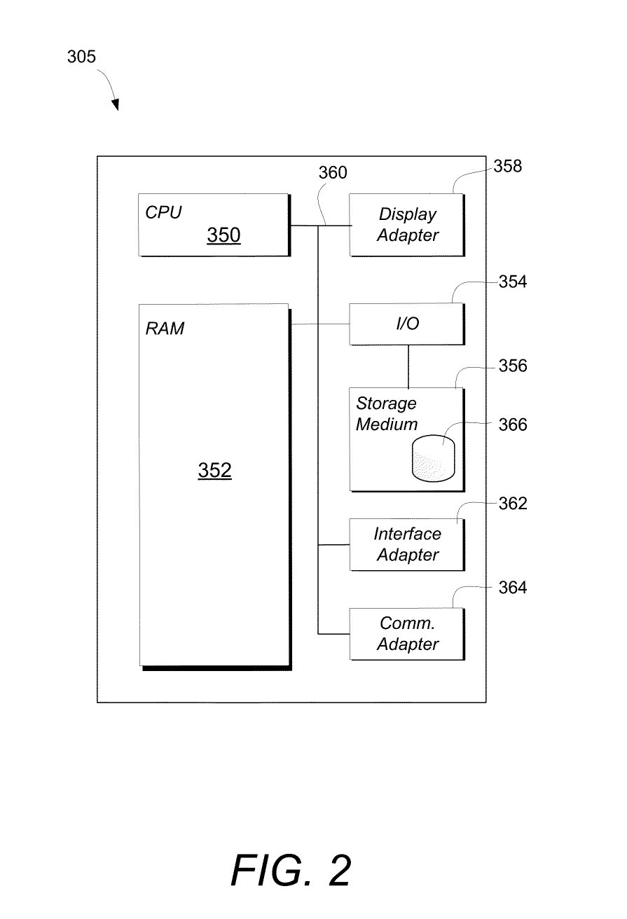

FIG. 3 shows an exemplary user interface for a mobile device configured to enable a user to navigate to functions and information within the system, view information, and control merchant subscriptions, in accordance with the present disclosure;

FIG. 4 shows an exemplary user interface for executing informational searches, in accordance with the present disclosure;

FIG. 5 shows an exemplary user interface associated with financial transactions, in accordance with the present disclosure;

FIG. 6 shows an exemplary merchant interface for controlling account settings, in accordance with the present disclosure;

FIG. 7 shows an exemplary merchant interface for displaying information associated with merchant offers, in accordance with the present disclosure;

FIG. 8 shows an exemplary merchant interface for generating, executing, and communicating information associated the merchant offers, in accordance with the present disclosure;

FIG. 9 shows an exemplary merchant interface for displaying information associated with redeemed merchant offers, in accordance with the present disclosure;

FIG. 10 shows an exemplary merchant administrative interface, in accordance with the present disclosure;

FIGS. 11 and 12 show exemplary user interfaces for a mobile device including social networking functions, in accordance with the present disclosure;

FIG. 13 shows an exemplary user interface for a mobile device depicting exemplary user loyalty functions and information, in accordance with the present disclosure;

FIG. 14 shows exemplary user interfaces for a mobile device depicting information and functionality associated with merchant offers, in accordance with the present disclosure;

FIGS. 15-18 shows various exemplary navigational and informational user interfaces for a mobile device, in accordance with the present disclosure;

FIG. 19 schematically shows an exemplary system for facilitating merchant-customer retail events, in accordance with the present disclosure;

FIG. 20 schematically shows an exemplary control diagram for implementing functions and modules of the system, in accordance with the present disclosure;

FIGS. 21-23 show exemplary user interfaces for a mobile device depicting various functionalities and information presentation modules, in accordance with the present disclosure;

FIGS. 24 and 25 show exemplary user interfaces for a mobile device depicting various functionalities and information associated with a virtual wallet system, in accordance with the present disclosure;

FIG. 26 is a flow diagram illustrating an exemplary informational flow to a user during operation of the system, in accordance with the present disclosure;

FIGS. 27 and 28 show exemplary user interfaces for a mobile device depicting various functionalities and information associated with displaying offers, in accordance with the present disclosure;

FIGS. 29-31 show exemplary user interfaces for a mobile device depicting a selected deal landing page display, in accordance with the present disclosure;

FIGS. 32-34 show exemplary user interfaces for a mobile device depicting a purchase displayed in the virtual wallet, in accordance with the present disclosure; and

FIG. 35 is an informational flow diagram illustrating exemplary use of the system, in accordance with the present disclosure.

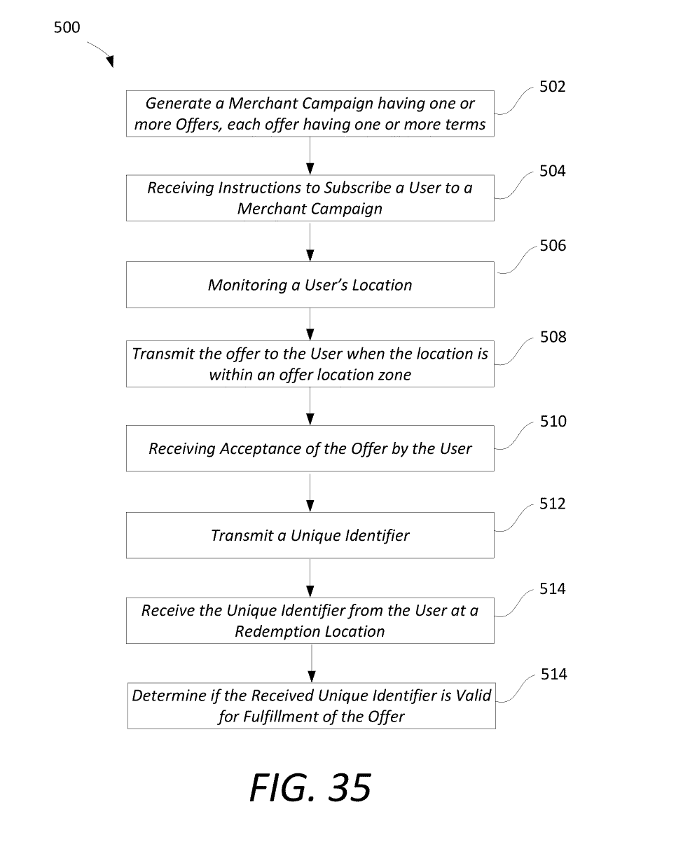

### DETAILED DESCRIPTION

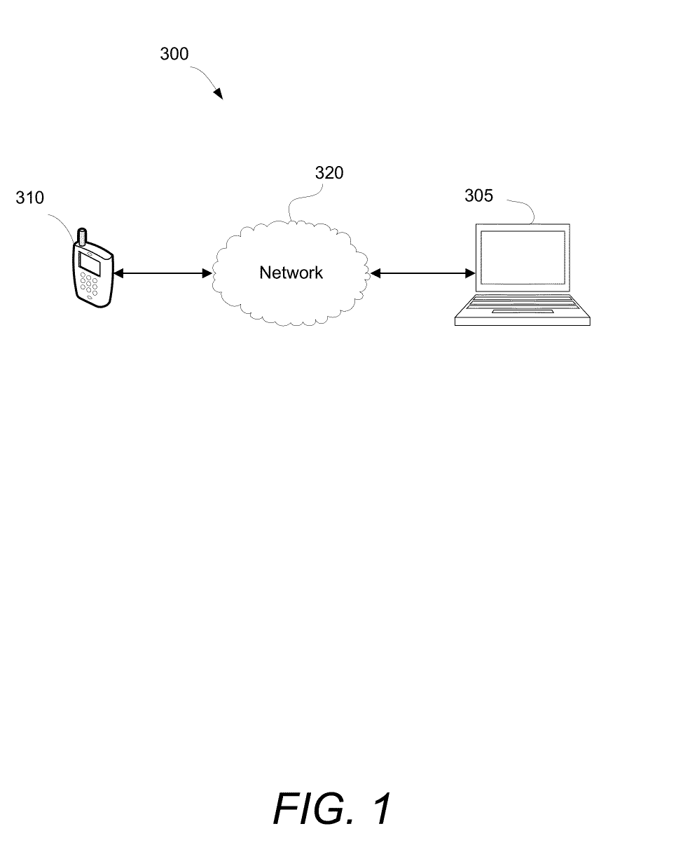

Referring now to the drawings, wherein the depictions are for the purpose of illustrating certain exemplary embodiments only and not for the purpose of limiting the same, FIG. 1 schematically shows an exemplary retailing system 300 that may help implement the methodologies of the present disclosure. The system 300 includes a server 305, a network 320, and a mobile device 310. As shown in FIG. 1, the server 305 may be directly communicatively connected and communicatively connected via the network 320. The mobile device 310 is preferably wirelessly communicatively connected to the network 320. Components of the communication system 300 are shown in FIG. 1 as single elements. Such illustration is for ease of description and it should be recognized that the communication system 300 may include multiple additional implementations of the components, e.g., a mobile device may be physically connected to the network 320 during selected periods of operation.

The network 320 may be any suitable series of points or nodes interconnected by communication paths. The network 320 may be interconnected with other networks and contain sub networks network such as, for example, a publicly accessible distributed network like the Internet or other telecommunications networks (e.g., intranets, virtual nets, overlay networks and the like). The network 320 facilitates the exchange of data between the mobile device 310 and the server 305. The most common topologies or general configurations of networks include bus, star and ring topologies. Networks can also be characterized in terms of spatial distance as local area networks (LANs), metropolitan area networks (MANs) and wide area networks (WANs). Further, memory located in or associated with the network 320 may contain algorithms or applications for executing functionality described herein.

The server 305 may be one or more of various embodiments of a computer including high-speed microcomputers, minicomputers, mainframes, and/or data storage devices. The server 305 preferably executes database functions including storing and maintaining a database and processes requests from the mobile device 310 to extract data from, or update, a database as described herein below. The server may additionally provide processing functions for the mobile device 310.

The mobile device 310 may be any type of communications or mobile computing device including e.g., a cellular phone, digital media player (e.g., audio or audio/video), personal digital assistant (“PDA”), e-readers, vehicle infotainment systems, navigation systems and a smart phone, which is a combination mobile telephone and handheld computer having PDA functionality. PDA functionality can comprise one or more of personal information management, database functions, word processing, spreadsheets, voice memo recording, location-based services, device backup and lock, media playing, Internet browsing, etc. and is configured to synchronize, publish/subscribe, download, or otherwise communicate personal information or user data (e.g., contacts, e-mail, calendar, notes, to-do list, web browser favorites, etc.) from one or more applications with a computer (e.g., desktop, laptop, server, etc.). The mobile device 310 preferably includes GPS functionality. In these embodiments, a GPS may determine the location of the mobile device based on data exchanges between the GPS and the mobile device. Other location services may be implemented to determine mobile device location. In some embodiments, for example, network elements may be used to determine location of the mobile device using triangulation of network signals, for example. Location may be determined at various intervals, upon occurrence of trigger events, upon requests, or the like.

In addition, the mobile device 310 may include one or more applications that the consumer may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

The application may organize input from the mobile device and transmit such input to the server 305 via the network 320. The application may also organize and display output received from the server 305 for the consumer, as will be described below. More specifically, the application allows the consumer to request offers based on identified Merchants. The application may acquire the location of the mobile device from the GPS, and in some instances, historical location information, and transmit the location to the server 305.

The server 305 includes a central processing unit (CPU) 50, random access memory (RAM) 52, input/output circuitry 54 for connecting peripheral devices such as a storage medium 56 to a system bus 60, a display adapter 58 for connecting the system bus 60 to a display device, a user interface adapter 62 for connecting user input devices such as a keyboard, a mouse, and/or a microphone, to the system bus 60, and a communication adapter 64 for connecting the server 305 to the network 320. In one embodiment, the communication adapter 64 is a wireless adapter configured for extraterrestrial communication such as in a communications satellite. The storage medium 56 is configured to store, access, and modify a database 66, and is preferably configured to store, access, and modify structured or unstructured databases for data including, for example, relational data, tabular data, audio/video data, and graphical data. One skilled in the art will recognize that embodiments of the server 305 can include additional components such as a high speed clock, analog to digital and digital to analog circuitry, and buffer circuitry and devices for appropriate signal conditioning. In one embodiment, the server 305 is housed or comprises a satellite communications system.

The central processing unit 50 is preferably a general-purpose microprocessor or central processing unit and has a set of control algorithms, comprising resident program instructions and calibrations stored in the memory 52 and executed to provide the desired functions. As one skilled in the art will recognize, the central processing unit 50 executes functions in accordance with any one of a number of operating systems including proprietary and open source system solutions. In one embodiment, an application program interface (API) is preferably executed by the operating system for computer applications to make requests of the operating system or other computer applications. The description of the central processing unit 50 is meant to be illustrative, and not restrictive to the disclosure, and those skilled in the art will appreciate that the disclosure may also be implemented on platforms and operating systems other than those mentioned.

The memory of the server 305 may include various storage databases including an offer database and consumer data database. Merchants may populate the offer database with offers as described herein below. In some embodiments, the merchants may use a virtual storefront to specify and transmit the details of offers. The virtual storefront may be a website that is specific to a particular merchant. In one embodiment, consumers may have access to both the virtual storefront for each merchant and the application. In another embodiment, the consumers may only have access to the application. In yet another embodiment, each merchant need not necessarily have its own virtual storefront. In other words, merchants may access a shared portal for transmitting offers to the system, whether the shared portal is a website, a program, etc. Merchants could log in to the shared portal with a unique username and password.

Still further, the system may compile information about specific consumers in the consumer data. For example, such information about consumers may include without limitation current locations, buying habits, recurring routes, preferences, interests, favorite merchants, purchase times, times at which offers are requested, and types of offers requested. Registered merchants may then use this information from the data records to develop even more intelligible targeting schemes. For example, a merchant could generate different offers for different consumers. Or the merchant could extend a personalized offer to a consumer during a specific time during the week when the consumer has purchased products from the merchant in the past. Or the merchants could analyze the data to determine which offers are most successful. One way for the merchants to obtain this information is through accessing their virtual storefronts or the shared portal.

The processor of the server 305 may perform the operations of user's as requested via the mobile device 310 and/or Merchants as requested by a computer system. To illustrate, the processor may organize and analyze raw data received from the mobile device and/or computer system. The processor may then store this data in the data records for merchant access. Similarly, the processor may select offers in the offer database based on the types of products and/or services that have been requested from the mobile device of the consumer. Selecting may include matching, filtering, choosing, deciding, electing, marking, picking, sorting, or otherwise refining the total number of offers before presentment to the consumer. The processor may additionally, or in the alternative, select offers based on the locations of the consumers. Still further, the processor may render expired offers in the offer database as being no longer redeemable based upon selected parameters as described herein below as defined by a Merchant.

After valid offers from the offer database are selected, in some cases based on the criteria discussed above, the server 305 may convey or transmit such offers back to the mobile device 310. The application of the mobile device may organize the offers and present them to the consumer in a user-friendly format as described and shown in the corresponding drawings. For example, the application may display the offers in a chart that indicates the offer, the distance from the consumer to the merchant, and the expiration time or quantity available. As a further example, the application may present the offers to the consumer as being graphically superimposed onto a localized map.

Although some of the features of the system have been described as occurring onboard the server 305, the present disclosure contemplates many other configurations and alternate systems. For instance, databases, or copies or subsets thereof, may be maintained in onboard memory of the mobile device 310 and/or computer systems of the Merchants. The retailing system 300 could continuously update the offer database onboard the mobile device based on the consumer's home city, current location, frequented or planned routes, or so on.

Another aspect of the application may allow consumers to set preferences concerning the retailing system 300. One preference may pertain to the timeframes during which the application on the mobile device may present the consumer with offers. Some consumers may prefer that offers are only presented to them when specifically requested. The application may allow a consumer to select a category of offers such as, for example and without limitation, entertainment, food, exercise, or grooming. The application allows a user to select a particular Merchant from which to receive offers. Alternatively, a user my select to receive offers from Merchants based upon the user's location. In this case, offers sent to the user may be limited by category. In one embodiment, a user may select Merchants to avoid.

Additionally or in the alternative, consumers could designate certain timeframes during the day, week, month, and/or year during which offers may or may not be presented. Consumers could also designate certain locations wherein the system would only present offers when the mobile device is within the designated location or outside the designated location. For example, a user may select a residence home or office to exclude receiving offers. Yet other exemplary preferences may pertain to how often offers are presented, what type or category of offers are presented, a threshold degree of discount for presentment, and so on. The offering may be based on a potential customer's location in time (e.g., in real-time), a potential customer's expected location later in time, or may be based on other parameters. Acceptance and redemption of the offers may be subject to a contingency and may be limited in time.

Once the consumer is presented with offers from merchants, the consumer may wish to accept an offer. The discount retailing system contemplates many methods through which the consumer may take advantage of a particular offer that the application presents.

The consumer may select a desired offer by indicating so through the application on the mobile device. The application may send a signal via the network to the server 305 indicating that the consumer would like to accept the offer from a particular merchant. Thereafter, the server 305 may generate an alphanumeric code, a two-dimensional scannable matrix such as a QR code, an electronic serial bar code, or some other unique identifier that is transmitted to both the application of the mobile device 310 and the merchant only when the user is within a preselected distance from the Merchant. In the alternative, merely information associated with the unique identifier may be sent to the merchant so that the merchant can recognize the unique identifier. The consumer may then show the merchant the unique identifying information upon redeeming the offer for the product, service, etc. It should be noted that real-time offers may also work in conjunction with the point system, as described previously. The distance may be selected by the Merchant or may be a preselected system-wide distance.

Although the discount retailing system has been described as collecting real-time offers from a plurality of merchants, the present disclosure also contemplates usage of the system by as few as one merchant. However, there may be benefits to having real-time offers collected centrally. In addition, where the retailing system is used with a plurality of merchants, consumers may choose to “follow” particular merchants, as described in more detail above. Following a particular merchant may allow the consumer to view all of the offers from the particular merchant, regardless of whether the consumer is within the vicinity of the merchant. Certain merchants may even provide special offers for its followers.

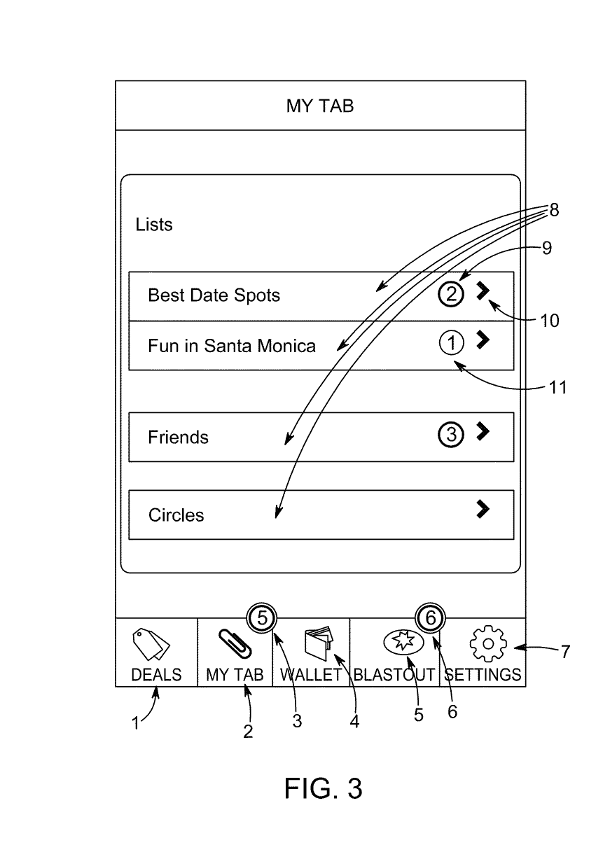

FIG. 3 shows an exemplary user interface for a mobile device configured to enable a user to navigate to functions and information within the system, view information, and control merchant subscriptions. The user interface includes dynamic navigational tabs. A first tab is configured to navigate to user control settings and, simultaneously, display information associated with notice of a merchant offer. The user interface enables the user to control of the filtering mechanism to determine which if any coupons or offers to receive from Merchants in a chosen geographical area or distance proximate to a Merchant.

As FIG. 3 shows, a “deals” navigational button 1, a “MyTab” navigational button 2 having an informational module 3, a financial navigational control button 4 (wallet), a merchant offer navigational button 5 (blast-out offer) having an informational module 6, a user settings navigational button 7, categories of Merchants—navigational buttons and associated offers 8, each having informational modules e.g., 9 and 11, wherein the merchant offers are navigable via an advance indicia 10.

In operation, a user may control the merchants from which to receive offers. The User selects merchants via search or via presentation of offers, from a database of merchants. The search may include location-based options, goods and service categories, etc. The user selects merchants that he wants to follow via the mobile app or web app, by pressing the “follow” button associated with that Merchant display. Any merchant chosen is archived for subsequent recall by the user. When one of the selected merchants creates a coupon offer or a non coupon limited time “Blast-out offer” offer, the User is notified by the appearance of an indicia 3. The indicia 3 may be a number within a circle in the upper right hand corner of the navigational button 2 such as shown in FIG. 3. When the consumer then presses the MyTab navigational button 2, all new offers from merchants he has elected to follow appear in subsequent user interface module along with one or more merchant offers. In one embodiment, the user can purchase any offer by pressing the purchase button, provided the user is within a geographical location, as will be described herein below.

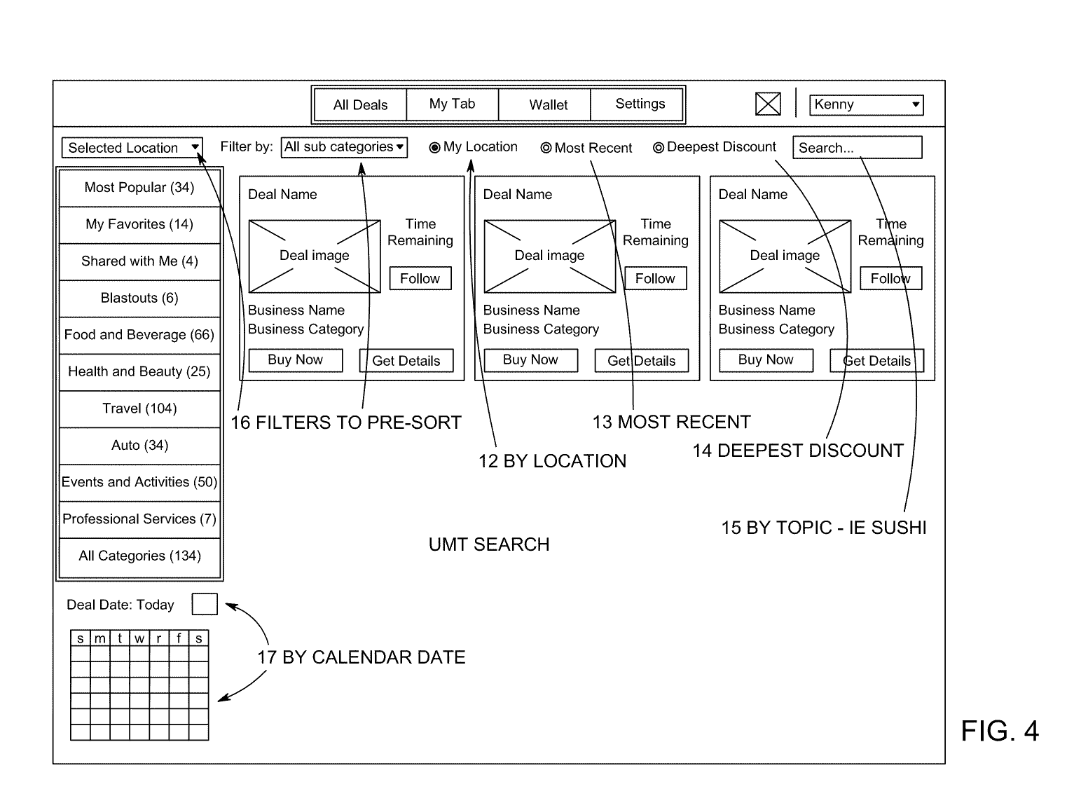

FIG. 4 shows an exemplary user interface for executing informational searches for an administrator or merchant-user. As FIG. 4 shows, the merchant-user may assess search functionality to identify various information including calendar segments, social group activity, user data, coupon offers or time and location-limited offers, i.e., Blast-out offers. The user can execute search queries from a database of available offers. Search functionality including queries and search results may be sortable or based upon such criteria as a good and service type, by merchant, by recent posting, by depth of discount, type of offering (e.g., Mexican or Sushi), by proximity to current location, by community or municipality defined region, by offers shared with him from other users, and by the date coupons or offers will be utilized.

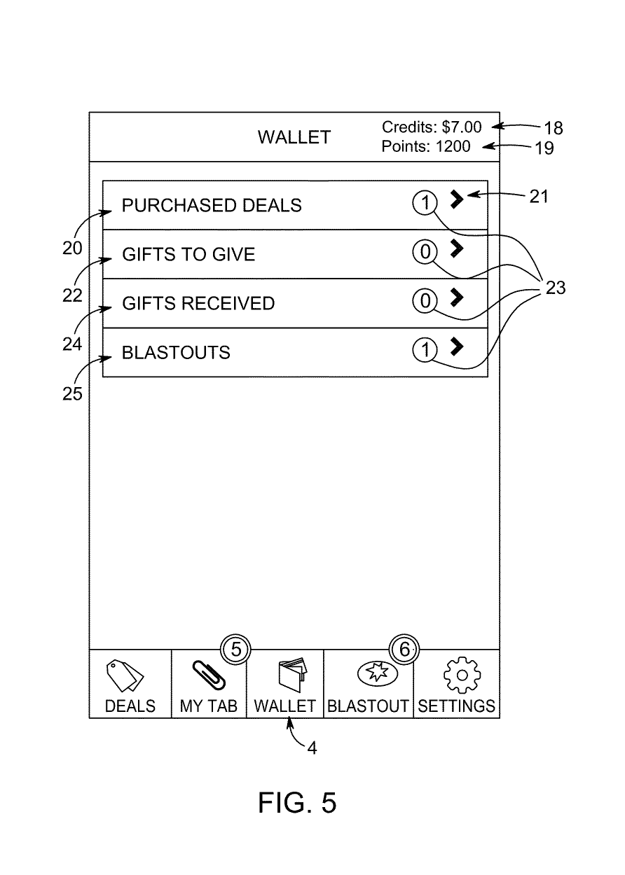

FIG. 5 shows an exemplary user interface associated with executing financial transactions. FIG. 5 shows various navigational buttons and informational modules and indicia including: Credit Balance in UMT Wallet 18, Loyalty Point Balance in UMT Wallet 19, Purchased Deals 20, Advance to Purchased Deals 21, Gifts purchased to Give 22, an Indicator of Purchased Deals 23, Gifts Received from Others 24, and Blast-out offers 25.

As described herein above, the user's mobile device may store information about a purchase transaction, such as information about purchased items, item prices, a location where items were purchased, and information about a method of payment (e.g., via an electronic receipt), etc. The virtual wallet may further store information that can be used in transactions and/or other types of information. For example, information associated with a credit card, automated teller machine (ATM) card, driver's license, bank account, and/or other types of information may be stored or associated with the virtual wallet. The mobile device 310 may send stored information to a destination, such as a remote storage device operating on the server.

The server 305, then in one embodiment, may further communicate with a third party on behalf of the mobile device 310. For example, the third party may be a bank that maintains financial accounts for a user listed and authorized in the virtual wallet. The server 305 may contact the mobile device 310 on behalf of the bank and may process transactions between the mobile device 310 and the bank (third party). Additionally, the third party may include a device that sends or receives information via the network 320 such as a device that verifies a credit card number.

Exemplary functionality of the virtual wallet includes: allowing third parties to gift into the wallet, either digital cash or coupons. (e.g., a parent can “gift” into a child attending university, or to an aging parent) The virtual wallet may be integrated with third party providers of institutional “currency” like university student credit voucher programs, and allowing a user to select the university currency, or some combination of system defined currency, university currency, and a third credit card or debit card or a proprietary “reward point system” for activity as a UMT Consumer. Further, the virtual wallet may allow the user to select either a credit, gift, or buy a coupon and gift to a named third party such as another system user. In one embodiment, the virtual wallet integrates records of purchases with current merchant interaction. Various user data associated with the virtual wallet may be stored locally or remotely. Purchased coupons information may be stored in the virtual wallet until redemption. In one embodiment, the virtual wallet integrates with refund and or credits from system merchants, so all transactions, purchases, deposits, and credits are facilitated in the virtual wallet functionality. Various encryption and security functions may be included as requiring user password and/or biometric input.

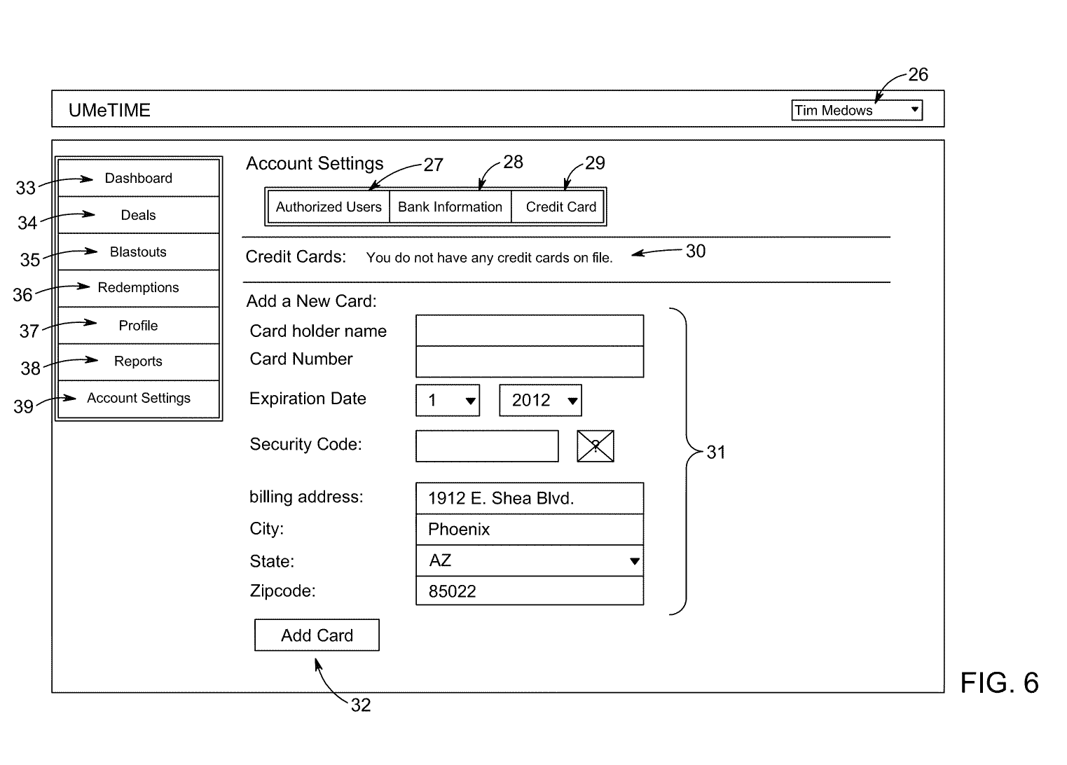

FIGS. 6-10 show various exemplary merchant interfaces for controlling account settings, displaying information associated with merchant offers, generating, executing, and communicating information associated the merchant offers, displaying information associated with redeemed merchant offers, and executing various administrative functions. In one embodiment, a merchant-user can create permission levels within the merchant administration portal to allow employees varied degrees of access and operability. The merchant-user may authorize access and degree of access on a person-by-person basis to the merchant's portal. The merchant-user can preferably manage the accounts receivable and refund interaction with consumers through the merchant portal. The merchant-user can preferably manage and interface with his accounting and tax professionals for activity business reports which can be created and exported to the common accounting systems, or in standard FASB format for distribution to others (e.g., accountants, banks, investors).

In one embodiment, a merchant-user may create a virtual storefront to market product offering such as a hosted merchant landing page to manage interaction with internet based promotional activities. The hosted merchant landing page can preferably be found through organic search on web-based search engines. The hosted merchant landing page can feature a profile of the merchant and their core offerings, and the current offerings available from the merchant. In one embodiment, a merchant is provided with a unique QR code that may be posted on all “non UMT promotions, e.g. print, video media, posters, etc., and when a consumer scans the code, the link from the code navigates the consumer-user first to any current coupon offer the merchant is sponsoring, and, if no current coupon campaign is under way, the link takes the consumer to the hosted merchant landing page. A merchant can customize merchant landing page assigned to that specific merchant with textual and graphical information. In one embodiment, each merchant is given a unique URL address for their landing page. Keywords and other searchable data may be provided to enable system users and internet users to locate the Merchant Landing page, i.e., search engine optimized techniques may be utilized.

FIG. 6 shows information associated with merchant account settings and specifically credit card settings, as navigated by a user selecting button 39 and then 29 of the exemplary merchant interface. As FIG. 6 shows, various navigational buttons, information modules, data input fields, and command control buttons can be included such as a user utilizing merchant account information 26, an authorized users navigational button 27, a bank information navigational button 28, a credit card navigational button 29, a credit card acknowledgement information module 30, various data fields associated with a new credit card 31, a submit new data for new credit card command control button 32, a dashboard navigational button 33, a general offers navigational button 34, a blast-out offers navigational button 35, a redemptions navigational button 36, a profile navigational button 37, a reports navigational button 38, an account settings navigational button 39.

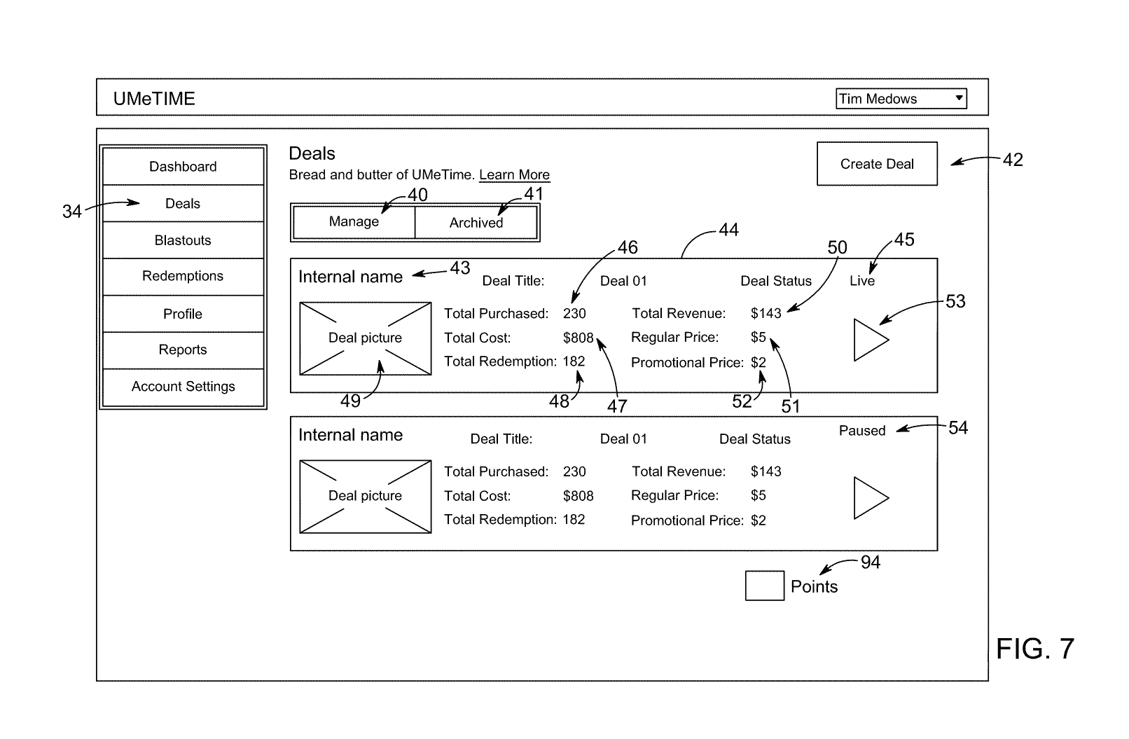

FIG. 7 shows information associated with general merchant offers, as navigated by a merchant-user selecting button 34 and then 40 of the exemplary merchant interface. In certain embodiments, a merchant may offer conventional offers and discounts along with time and location-limited offers as described herein above. Navigational buttons, information modules, data input fields, and command control buttons are preferably included to enable a merchant-user to generate deal offers, send to users, and view information associated with the offered deals, including: a manage navigational button 40, an archived navigational button 41, a create deal navigational button 42, an internal name information 43, a deal number information 44, a deal status information 45, a total coupons purchased information 46, a total cost information 47, a total redemptions information 48, a deal graphical information 49, a total revenue information 50, a regular price information 51, a promotional price of deal information 52, and an advance to see deal screen navigational button 53, and 54 paused deal status.

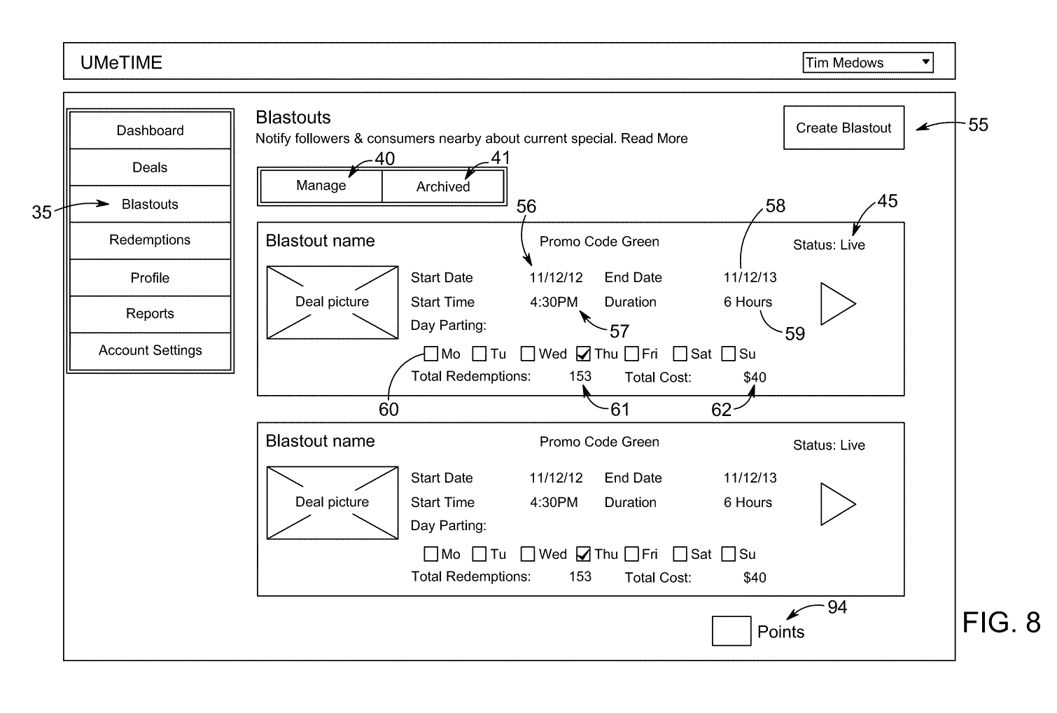

FIG. 8 shows information associated with blast-out offers, i.e., time and user location-limited offers as navigated by a merchant-user selecting button 35 and then 40 of the exemplary merchant interface. Navigational buttons, information modules, data input fields, and command control buttons are preferably included to enable a merchant-user to generate blast-out offers, send blast-out offers to consumer-users, and view information associated with the merchant offers, including: a create blast-out offer navigational button 55, a start date of blast-out offer information 56, a start time of blast-out offer information 57, an end date of blast-out offer information 58, an end time of blast-out offer information 59, a day of week blast-out offer to run input fields 60, a total redemptions of blast-out offer information 61, a total cost of redemptions of blast-out offer information 62. In one embodiment, the redemption portal is configured to reconcile redemption by either scanning in a QR code, or entering a unique number or code identifier, to initiate reconciliation of the redemption to the proper category and “flight”.

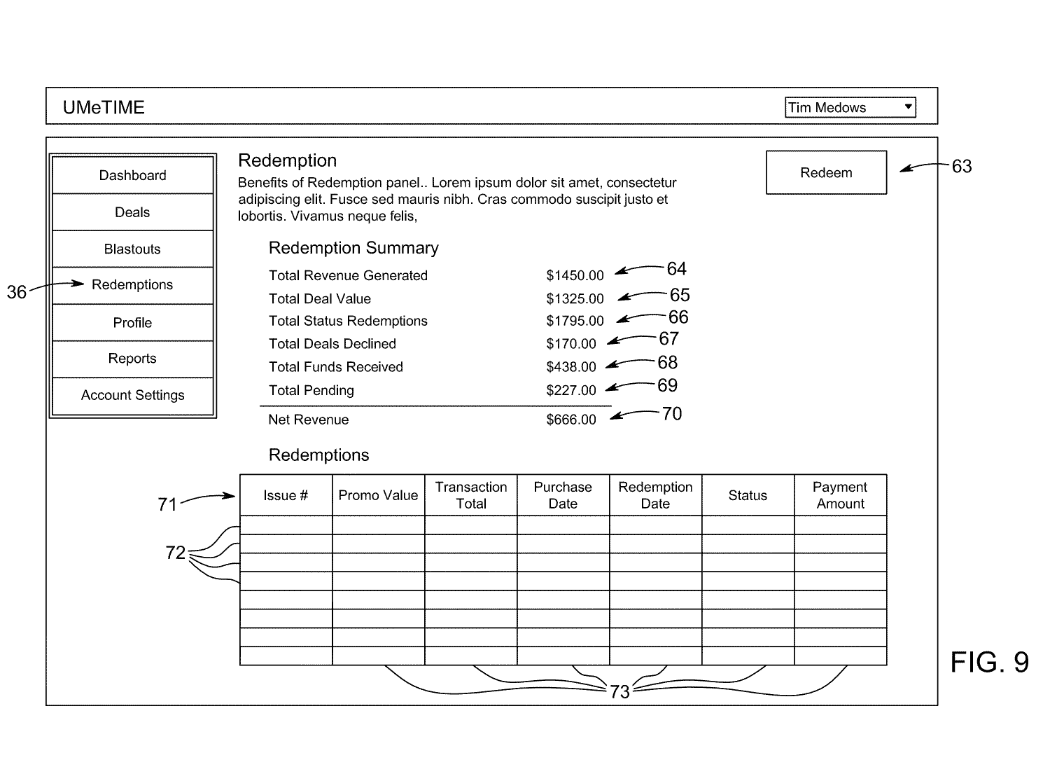

FIG. 9 shows information associated with redemptions as navigated by a merchant-user selecting button 36 of the exemplary merchant interface. Navigational buttons, information modules, data input fields, and command control buttons are preferably included to redeem merchant offers and display information associated with redemption including a redeem offer navigational button 63 and information such as: total revenue generated through offers 64, total deal value at retail 65, total status redemptions of offers 66, total deals declined 67, total funds received 68, total pending deals not redeemed 69, net revenue to merchant on deals offered and redeemed 70, issue identification number for coupon entry 71, multiple issue number entry capacity 72, and a plurality of various data populated by enterprise platform matching coupon number 73. In one embodiment, the redeem button 63 is a command button enabling a merchant-user to enter an offer code 71, whereby the server 305 populates the data field with information associated with the offer code 71. The merchant-user may then redeem the offer code by activating the redeem button 63.

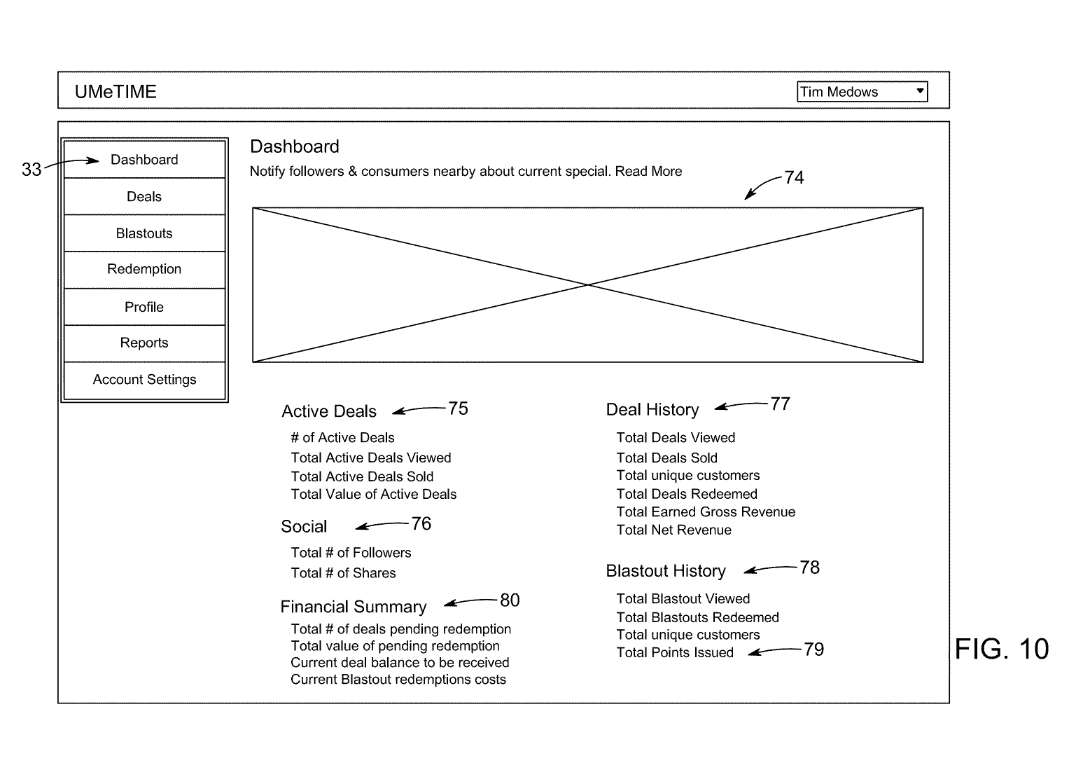

FIG. 10 shows an interface for displaying information associated with a merchant account including financial statistics, performance information, and general activity information. The information may be displayed by a merchant-user selecting button 33 of the exemplary merchant interface. In one embodiment, the information module may incorporate communication modules 74 such as for displaying merchant to merchant communications and/or user communications. Other exemplary information includes: active deals report 75, social networking report of data to merchants 76, deal history 77, blast-out offer history 78, points issued by merchant to customers 79, merchant current position 80.

Utilizing the merchant interface, a merchant-user may create a coupon campaign. Campaign generation via the interface can include: building the coupon offer, determine the terms of the coupon offer, uploading graphical information to promote the offer, set an open and close dates for launch, or in the alternative, set the number of coupons to be offered and stop the campaign automatically when the desired number is reached, and display real time analytics of a current campaign delivered to the merchants portal report. Through the merchant administrative portal, a merchant-user may monitor campaign amend the offering stop the offering, extend the offering in a next “flight”, and study the analytics as to activity, absorption, frequency of view, clicks, purchase, gifting, and redemption. In one embodiment, a merchant-user can monitor business impact of activity including redemption of coupons or blast-out offers, coupons sold but not redeemed, and the performance/success of one campaign versus other campaigns conducted by same merchant.

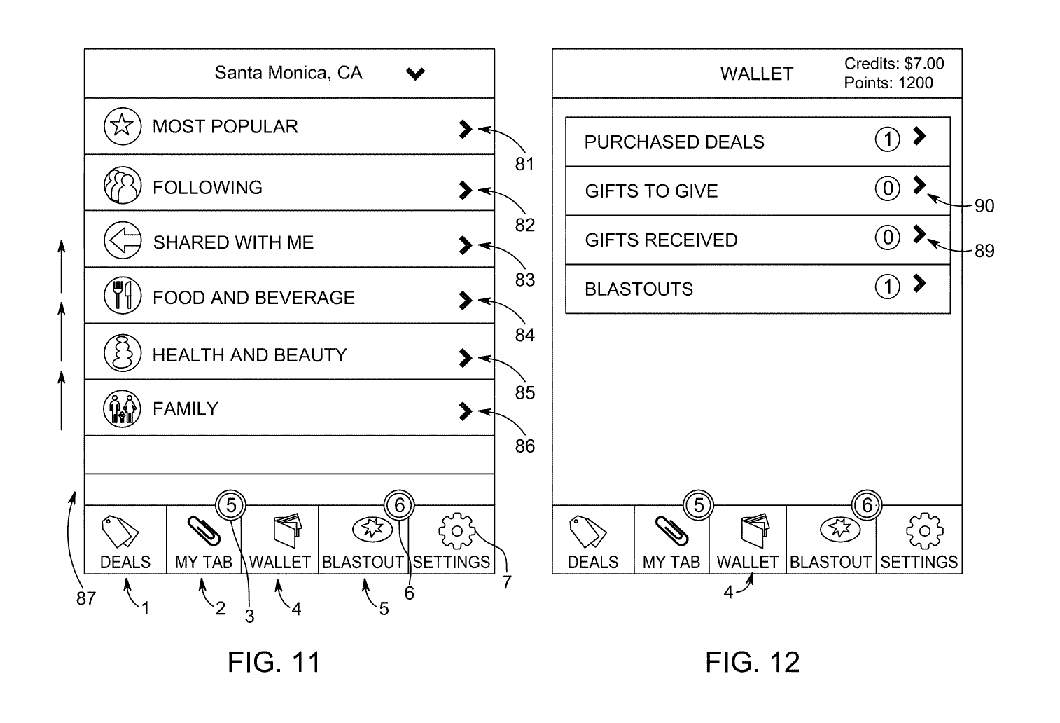

FIGS. 11 and 12 show an exemplary user interface for a mobile device including social networking functions and information. The user interface preferably enables a user to share information to other users within and outside of the system including users of social networking systems. In one embodiment, users may follow other users to find “deals”, or promote “deals” to other users in social networks systems, or gift deals, through a fully enabled mobile application or web based application social networking capacity, as well as forward information via sharing sites, social networking systems or conventional communication means such as email. Social networking capacity is preferably integrated with the coupon offer program and the blast-out offer program. In one embodiment, a user can follow friends, alert friends to deals, or use deals to coordinate a meeting at a particular merchant.

As FIGS. 11 and 12 show, the user interface may include various exemplary navigational buttons, information modules, data input fields, and command control buttons such as a most popular navigational button 81, a following navigational button 82, a shared with me navigational button 83, a food and beverage navigational button 84, a health and beauty navigational button 85, a family navigational button 86, a scrolling function 87, a select a city function command control button 88, a gifts received navigational button 89, a gifts to give navigational button 90. A user may utilized the various navigational buttons to share information including offers and coupons as described herein above, view information, and exchange information with others.

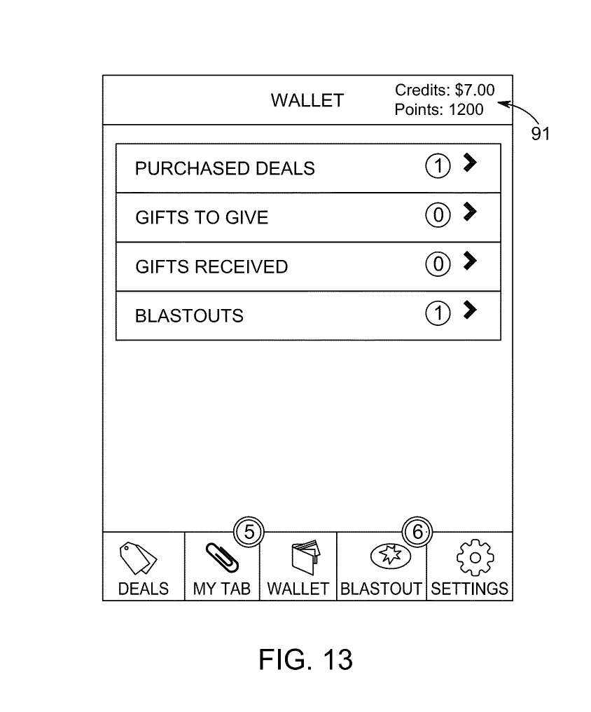

FIG. 13 shows an exemplary user interface for a mobile device depicting exemplary user loyalty functions and information. As described above, a reward or loyalty program may be used in conjunction with the retailing system. In the incentive or loyalty program, consumers are encouraged to collect points from that merchant, which can then be redeemed for awards either from that merchant or from other merchants in which different merchants have arranged such sharing of points. Along those lines, the disclosure contemplates an exchange program in which customers that have already purchased deals (or have collected loyalty points from a particular merchant), can exchange those deals or points for money, loyalty or rewards points or other deals either with the particular merchant or with other merchants or with the owner and manager of the website. Accordingly, the exchange or exchange program allows members or groups of members to offer to sell or exchange their deals for money or other deals.

In one embodiment, points may be earned by purchase of UMT offers, may be earned by referral of offers to other users, may be earned by encouraging other consumers to download and use the proprietary applications, may be purchased and distributed by a merchant to repeat customers, may be purchased and gifted by a user may be purchased and utilized by a user, may be gifted to a third party such as an individual, corporate entity or a charity, and/or may be exchanged for valuable prizes and gifts. In one embodiment, loyalty points allow a user to receive additional non-cash benefits for participation in proprietary community games of chance and win awards such as travel, event tickets, or valuable prizes. The loyalty points 91 may be recorded and noticed in the virtual wallet system as shown in the exemplar user interface of FIG. 13. In one embodiment, the loyalty points may be purchased, recorded, managed, and distributed as consumer reward programs by a merchant in the merchant portal 79.

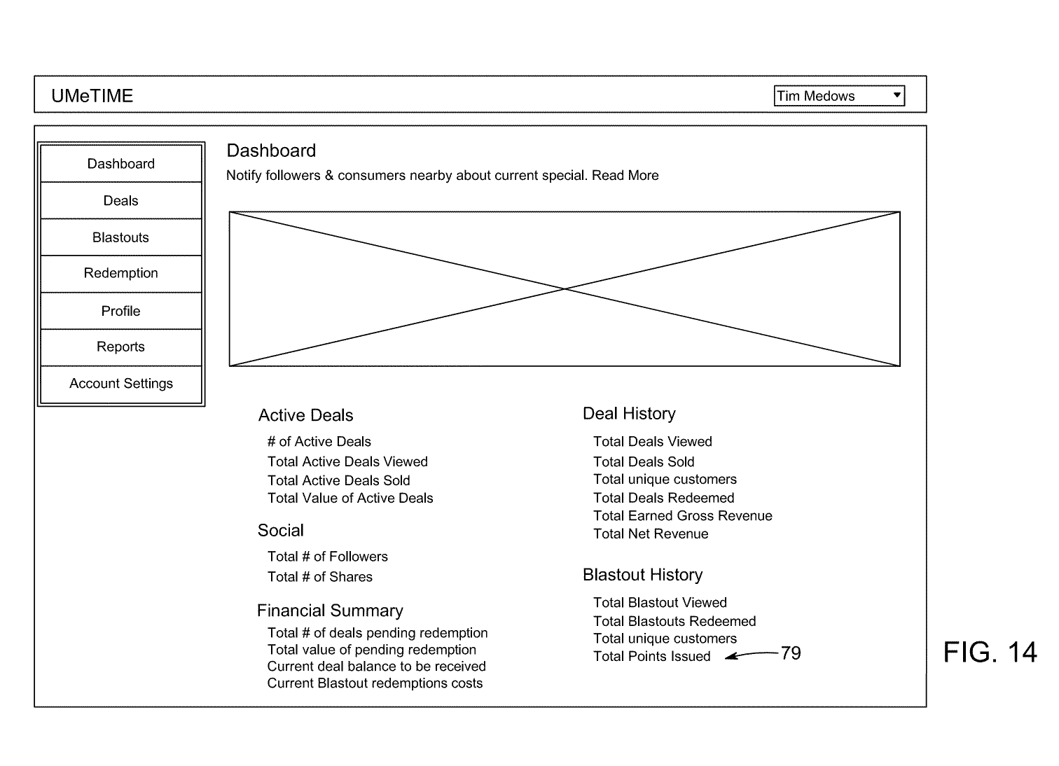

FIG. 14 shows exemplary user interfaces for a mobile device depicting information and functionality associated with merchant offers (i.e., blast-out offers), redemption codes, and redemption informational fields. As described herein above, the system enables Merchants to create offers that are time-limited i.e., have valid open and closeout times, include descriptions and terms of the offer. The offers may be created using the merchant-interface described herein above including with reference to FIG. 8.

In one exemplary application of the disclosure herein, a consumer is directed to register personal profile information in the settings subsequent to installation or initial load of a user application. In operation, a user is notified of offers in the immediate vicinity via the UMeTime application in either the Blast-out offers feature, or on the Consumer's My Tab repository, and selects a merchant's offer. The user cannot redeem the offer unless the geo positioning functionality of the smartphone confirms the consumer is at or within the sponsoring merchant's establishment. Upon entering the predetermine locational area a user can then select redeem, and the Merchants offer appears with a unique identifier and a QR code which may be scanned by the merchant or simply acknowledged, and the consumer is then qualified to redeem the offer. In addition to receiving the value of the discount of the “special offer”, the user may also receive loyalty points, award points for use of the application. The system preferably records all transaction data, and provides real time analytics to the Merchants, along with processing the subscriptions and fees for services.

In operation, the Merchant controls the offer terms to be delivered in real time through a proprietary Merchant Management Portal, i.e., the merchant interface, as described herein above. This portal allows a merchant to: set the terms of the offer, Upload the description of the offer, along with image or video promotional content, set the open and close time segments for the offer, determine if a promo code is desired, enter a promo code if one is desired, monitor the number of users in proximity of the business, monitor the number of users that receive the offer, monitor the number of users that click to review the offer, monitor the number of users that tried to redeem the offer but were not close enough to the merchant's location to redeem the offer, monitor the number of users that actually redeem the offer, scan the unique code assigned to the offer from the user's phone, export the accounting data from the portal to be integrated with the merchants bookkeeping and accounting system, record a unique alphanumeric number assigned to that particular offer into the merchants bookkeeping system, monitor the redemptions and attempted redemptions in quarter hour segments during the open period of the offer, optional acquisition of loyalty points which may be added to an offer redemption to encourage the customer to become a frequent customer of the merchant, with or without a special promotional offer.

In one embodiment, the User selects the methodology to be notified of Blast-out offers. The user can receive the Merchant's Blast-out offer in two ways in the Mobile Application and the receipt of the offer is facilitated in one of two UMT archives: by enabling “blast-out offers” in the settings within the UMT application or by ‘following’ a particular, selected merchant. Once enabled, every UMT user within a predetermined radius, geographical area, and/or defined municipality will receive notice of offers created by local merchants in the UMT application feature, “Blast-out offers”. Notice of new offers may appear as an indicia such as a small circle with a notation of the number of current local Blast-out offers offers.

To view information associated with the merchant offer, the user may navigate using a navigational button such as button 5. Upon selection, information associated with the offers appear including, for example, the offer, the merchant, time remaining on the offer, and/or distance or travel time from current location to the Merchant location. Offers may appear in order of closest proximity to farthest away from the user's current location, by degree of discount, or by probability of use as determined by user settings, preferences, and/or user history.

As described herein above, the user may also receive notice of a Blast-out offer in their customized MyTab feature of their UMT application. If a merchant creates a blast-out offer, the user following that merchant's activity will receive notice of the Blast-out offer in their MyTab, irrespective of the user's current location. To redeem an offer noticed through the UMT MyTab Feature, the consumer must be in proximity to the merchant making the offer. If an attempt is made to redeem a Blast-out offer removed from the predetermined geographical area, or distance from a Merchant, the application refuses to authorize redemption, and the consumer is encouraged to go to that establishment to redeem. If the Merchant has required a promo code, the merchant must make the promo code available to the users, which is then enterable on the mobile app and then the coupon is redeemed. If the consumer is at the Merchant's establishment, the consumer presses the redeem button, and the system assigns that particular redemption “call” a unique identifier code, and/or a unique QR code. The redeemed code is reconciled with the merchant's account for analytics and for billing purposes. Once a redemption code has been assigned to that particular “call” from that particular user's mobile device, the sponsoring merchant may be billed a predetermined amount by the system for use of the feature. When a user has redeemed the offer, loyalty points may be awarded to the user's account.

In one exemplary application of the system, a merchant pub owner has a slow traffic period on a particular weekday afternoon from 3 to 5 p.m. He has wait staff, cooks and bar tenders but no customers. He is reluctant to put advertisements in newspapers or on the web, or interact with coupon vendors with discounting mechanisms as it is likely to “cannibalize” his normal business trade. He signs on as a system merchant, and subscribes for the right to distribute limited time offers in real time through the proprietary system. He signs into the Merchant Portal, selects create offer, and in a matter of minutes, builds a “half off appetizers” from 3-5:30 p.m.; selects Blast-out offer, and system users within a predefined distance or area of his pub receive a notice that the offer is live. Accepting or interested users present their phone to verify receipt of his offer. Upon expiration of the offer, the offer is delisted by the system and removed from the available Blast-out offer notices in the Wallet consumer's phone. The Merchant receives notice in his Merchant Offer Management Portal account.

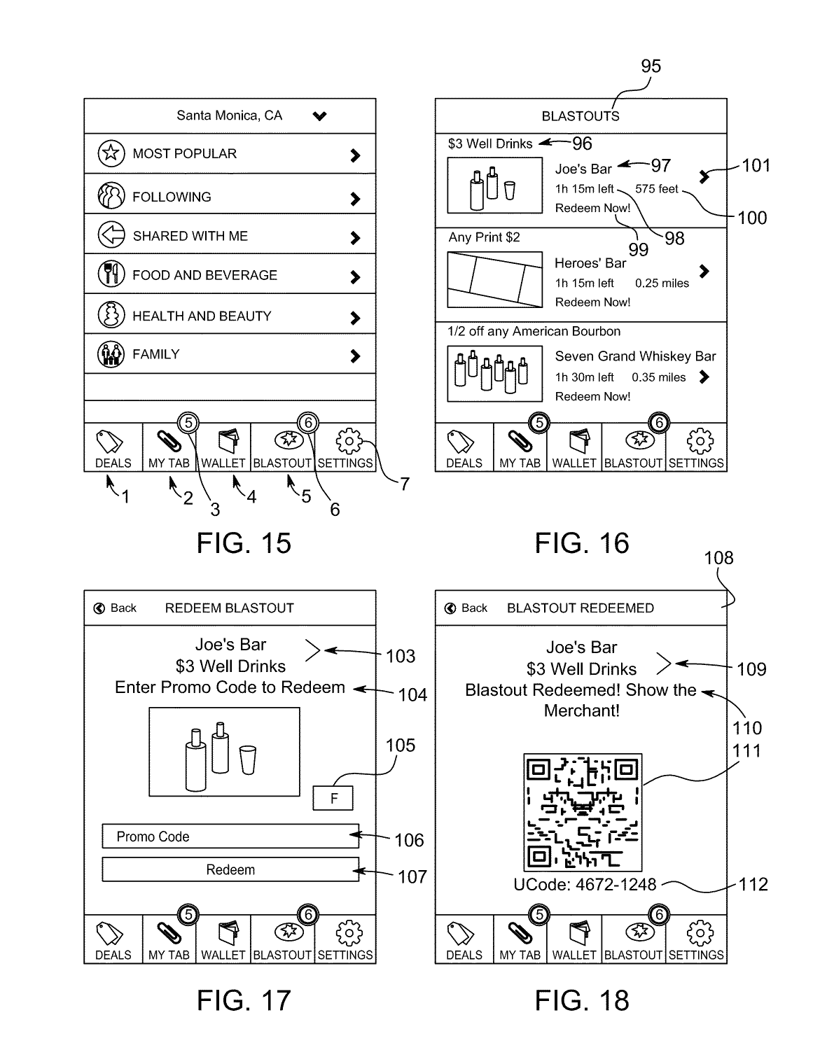

FIGS. 15-18 shows various exemplary navigational and informational user interfaces for a mobile device including a blast-out offers landing page 95 that includes: an exemplary offer 96, an associated merchant 97, time remaining before offer expiration 98, a redemption command button 99, information associated with merchant proximity 100, and a navigational button to direct a user to the merchant's landing page 101.

Upon selection of the navigational button 101, a user is directed to a landing page associated with the merchant's offer 102. The offer landing page may include information associated with the merchant and the offer 103, further details of the offer, e.g., promo code notice 104, a command button to share with a social networking system 105, a field to enter the promo code 106, and a command button to redeem the merchant offer 107.

Upon selection of the redeem command button 107, the mobile device may display a redemption landing page 108. The redemption landing page may continue to provide include information associated with the merchant and the offer 109, notice of redemption and instructions to show the merchant 110, an scanable code, such as a bar code, or QR code 111, and a unique alphanumeric code associated with the offer and this redemption created and delivered to the app 112.

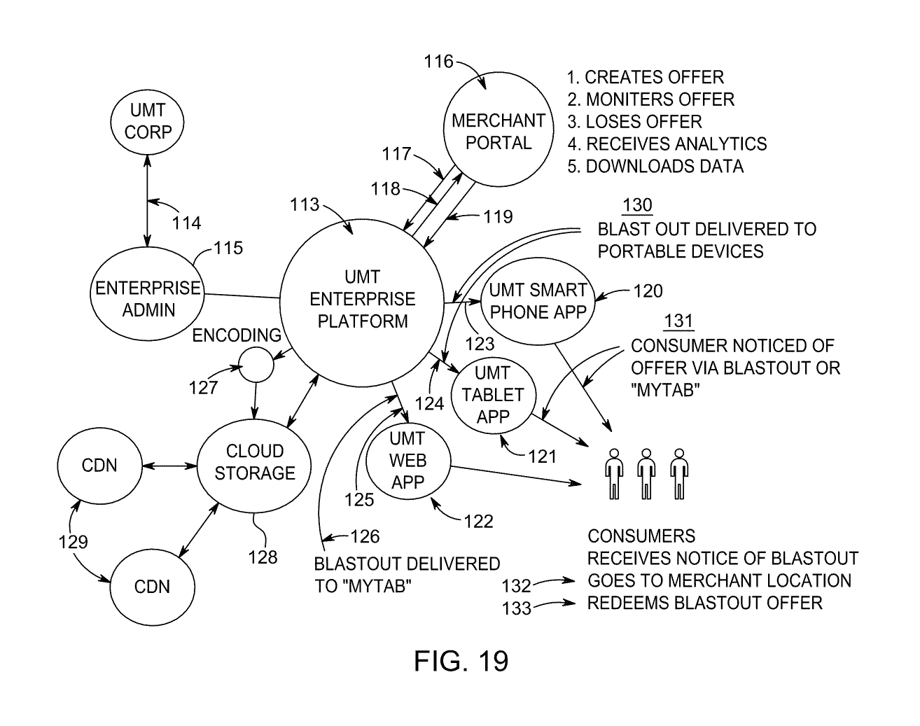

FIG. 19 schematically shows an exemplary system for facilitating merchant-customer retail events. In one embodiment, the system supports, operates, and integrates the offerings through various platforms (web, mobile, tablet) with backup functions. In one embodiment, the system platform includes an enterprise platform 113, a corporate interface for various system-wide administrative functions 114, enterprise administrative functions 115, the merchant portal 116 including merchant uploads coupon deal offer or blast-out offer 117, merchant receives data on offer or blast-out offer 118, merchant has capacity to amend deal or blast-out offer 119, smart phone application 120, tablet application 121, web application 122, real time data share capacity with mobile application 123, real time data share capacity with tablet application 124, real time data share capacity with web application 125, blast-out offer delivered to mytab in web application 126, third party encoding of merchant video for re-provisioning for mobile and web 127, remote and cloud storage 128, real time redistributed storage to cdns 129, blast-out offer delivered to smartphone devices 130, customer notified of blast-out offer in either blast-out offer tab, or in mytab 131, customer reviews blast-out offer 132, and customer travels to merchant offering blast-out offer to redeem 133.

In one exemplary application of the teachings herein, a merchant-user creates two different types of offers. For an exemplary coupon campaign, the merchant-user makes available 40 coupons for a: $50 value, dinner for two, only redeemable between the hours of 4:30 and 6:30, on Tuesday and Thursday nights, for the coming month, and retail it for $25. Additionally, the merchant-user creates a blast-out offer of a free appetizer with a two drink order during happy hour. I put a promo code of 007 on the offer, and arrange for the blast-out offer to go live each day this coming week, e.g., Monday-Thursday at 2:00 p.m., offer good from 5-6:30. The merchant-user may monitor progress on each campaign. On the coupons, the merchant-user can view quantity sold. On the blast-out offer the merchant-user may view how many are responding to my 007 blast-out offer, for example.

When the coupon offer is redeemed by a user, the merchant-user may simply add the unique identifier to the ticket when they take the order, and the cashier enters it into the merchant portal, signifying the coupon has been redeemed, and setting my restaurant up for any payment from the system for the redemptions. At the end of the month, I pull the report from the merchant portal and forward it to my bookkeeper. When the user enters the merchant's establishment, they show the blast-out offer for redemption of the offer and to initiate transactions between the Merchant and the system for a successful redemption via the Merchant Portal account for delivery of each customer the merchant establishment. The merchant-user can extend, renew, amend, substitute or stop any promotional offer in real time.

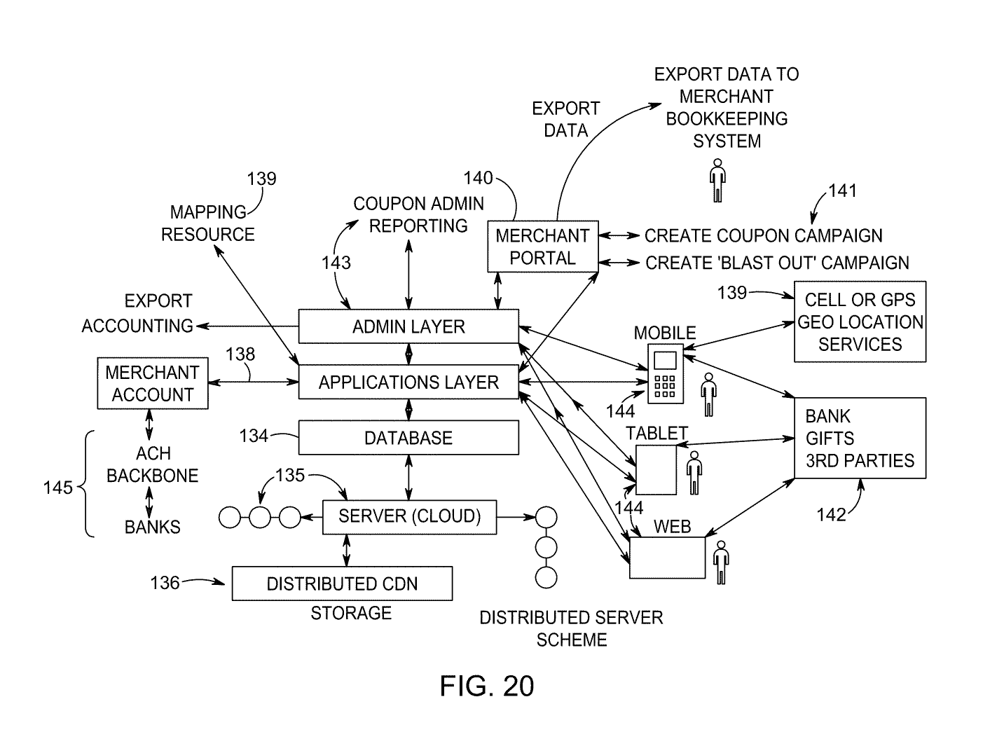

FIG. 20 schematically shows an exemplary control diagram for implementing functions and modules of the system 300. The exemplary system includes a data repository 134, one or more servers in a “cloud” network 135, a back up storage in CDN 136 or other data storage device, applications layer running over data 137, a merchant account processing interface module 138, a mapping resource to enable integration with blast-out offer and local deals 139, a merchant portal preferably having interface, and integration with applications and mobile devices 140, offer and delivery relationships 141, an integration with non-platform third parties (people making gifts to e.g., students, university currency programs,) 142, an administration layer for data distribution, accounting, audit, and regulatory compliance 143, integration and delivery support for predetermined selected distribution devices: e.g., smartphone, tablet, and web 144, and interface with banking and ACH backbone 145.

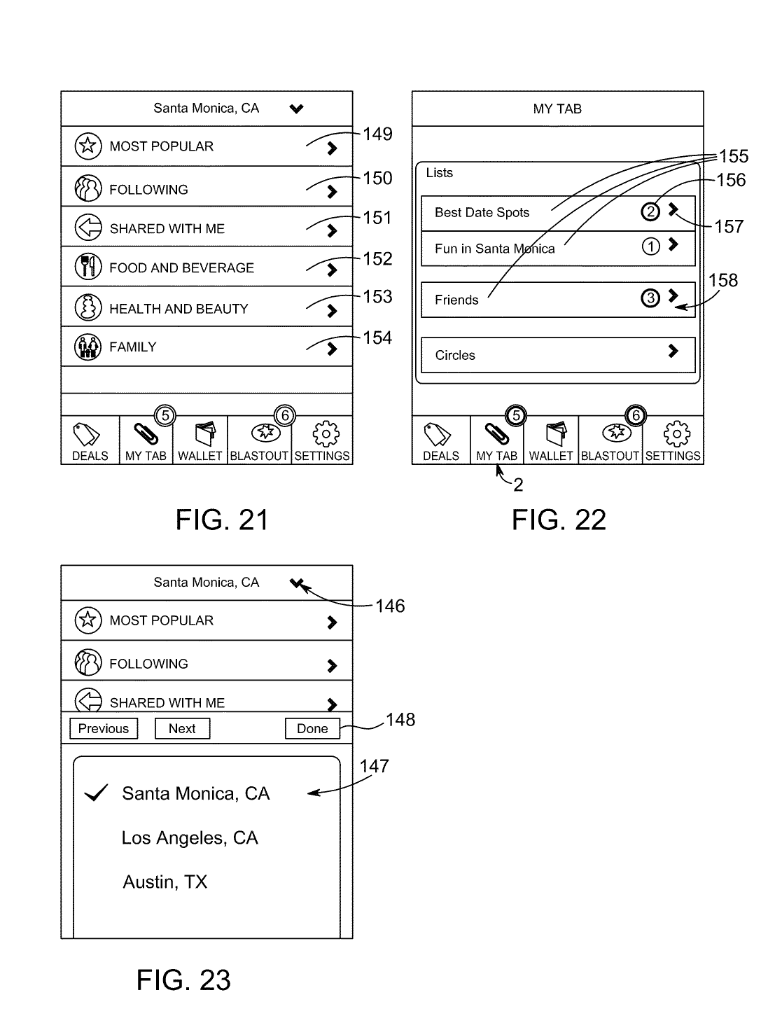

FIGS. 21-23 show exemplary user interfaces for a mobile device depicting various functionalities and information presentation modules. As FIGS. 21-23 show, a user may select or search via municipality region such as a city and state 146 and 147 and authorize selection of city 148. A most popular navigation button 149, a following navigation button 150, a shared with me navigation button 151, a food and beverage navigation button 152, a health and beauty navigation button 153, and a family navigation button 154 may be utilized in one exemplary embodiment. The family category may be supplemented or added with another defined group. Various other navigational categories may be utilized or defined as shown in 155, e.g., notice of new offers in categories selected by user 156, review new offers in categories selected by user 157, and color of offer notice indicates reviewed previously or to be reviewed 158.

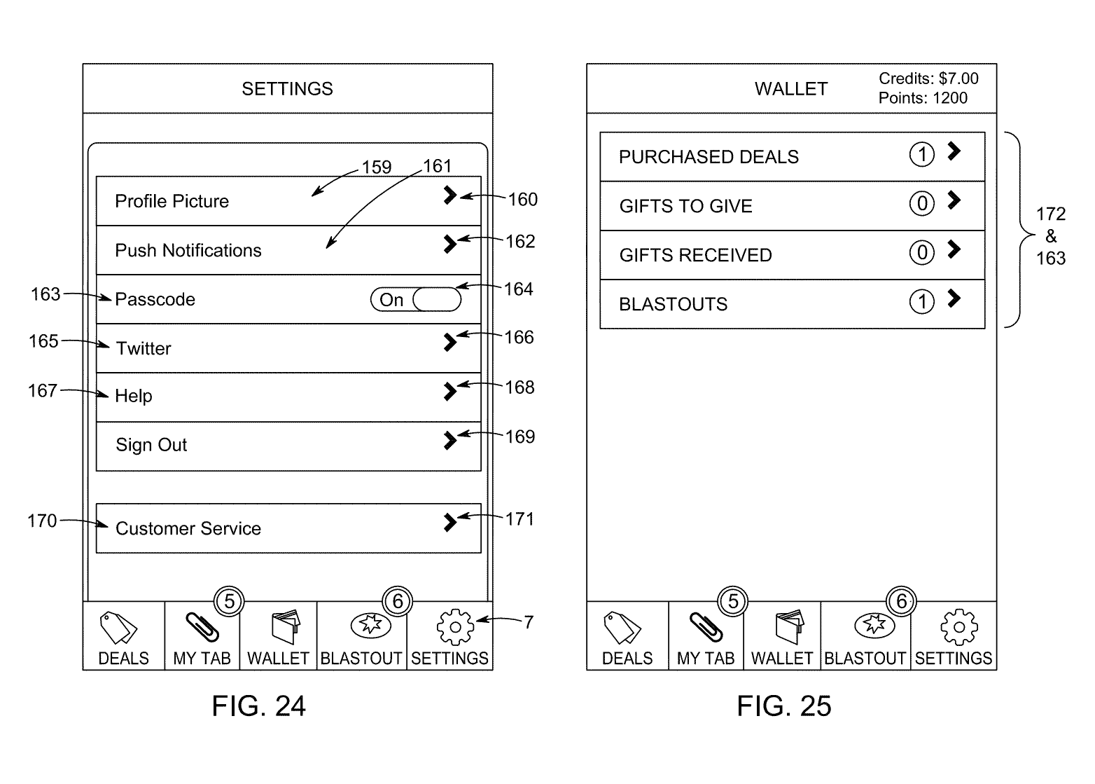

FIGS. 24 and 25 show exemplary user interfaces for a mobile device depicting various functionalities and information associated with the virtual wallet system described herein above. As FIGS. 24 and 25 show, a virtual wallet system may include functionality to store and view a profile picture 159, upload or edit function for profile picture 160, display push notifications 161, configured push notifications 162, configured passcode 163, display passcode on or off 164, display a communications network 165, configure the communications network access 166, display a help menu 167, provide access to help menus 168, sign out of settings 169, provide customer service access repository 170, provide customer service repository access 171, and provide a summary of transactions in the virtual wallet 172.

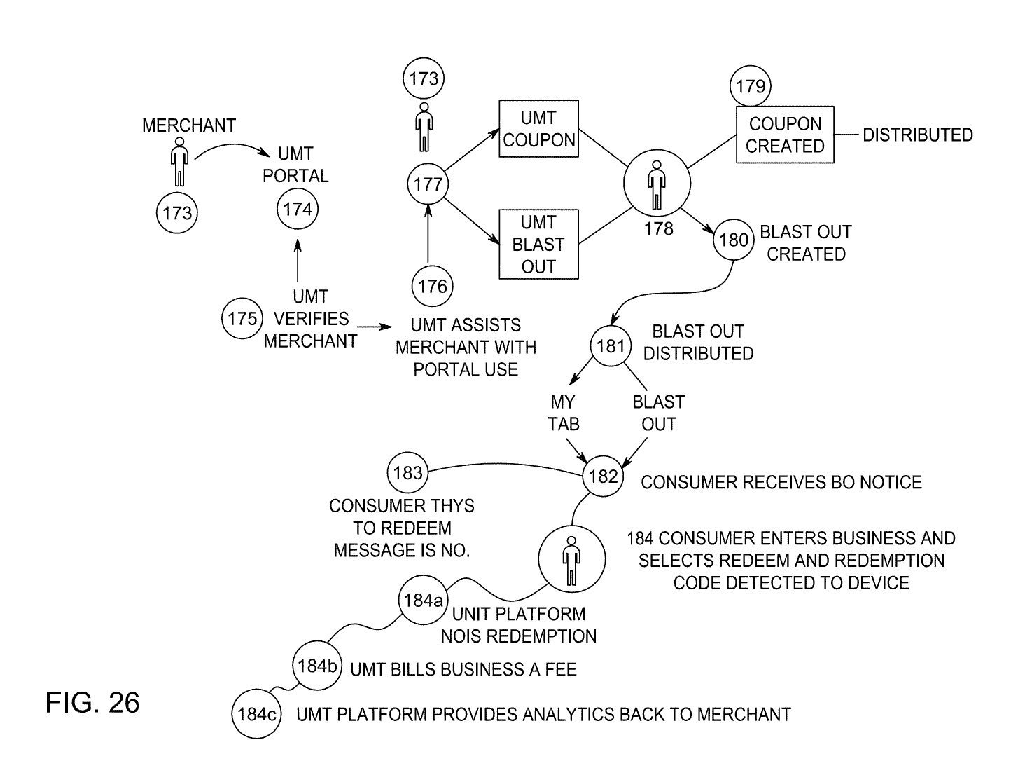

FIG. 26 is a flow diagram illustrating an exemplary informational flow to a user during operation of the system 300. During operation, the merchant registers business on the network 173, a portal for offer management is actuated 174, a merchant-user may verify business 175, the system preferably turns business access ON to create deals 176, a merchant-user may select coupon or a blast-out offer creation button 177 within a portal, a merchant-user may then build a coupon offer or blast-out offer campaign 178, a coupon is distributed to users of the system 179, a blast-out offer is created and distributed based on the selected go-live time selected by merchant 180. The system distributes a notice of the blast-out offer to mytab for consumer-users following the business. In one embodiment, the system distributes the notice of the blast-out offer to those in an immediate vicinity of the business 181. Upon transmission of the blast-out offer, the consumer-users receive blast-out offer notice in their device 182. When a consumer-user attempts to open the blast-out offer but is not in proximity to business making offer, the system prohibits access to the offer 183. However, in one embodiment, when the consumer-user travels to a merchant-business associated with the blast-out offer, and the user may access the notice and receive a redemption code to show to merchant 184.

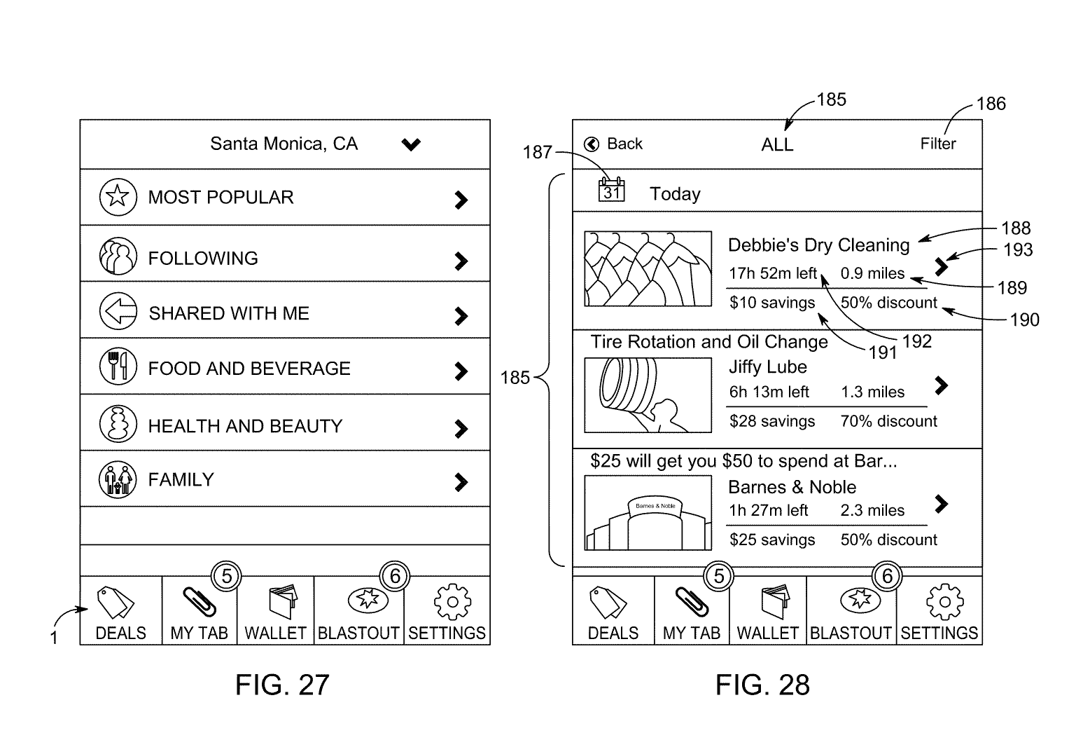

FIGS. 27 and 28 show exemplary user interfaces for a mobile device depicting various functionalities and information associated with displaying offers. In one embodiment, a list of deals may be displayed 185, a search and filter mechanism 186, a date of the deals being displayed with ability to search different date 187, the particular merchant associated with the coupon offer 188, a distance or travel time from the smartphone displaying the offer to the particular merchant making the offer 189, a total discount from retail 190, a dollar amount of savings 191, a time left until offer is withdrawn 192, and/or a select to view details of offer 193.

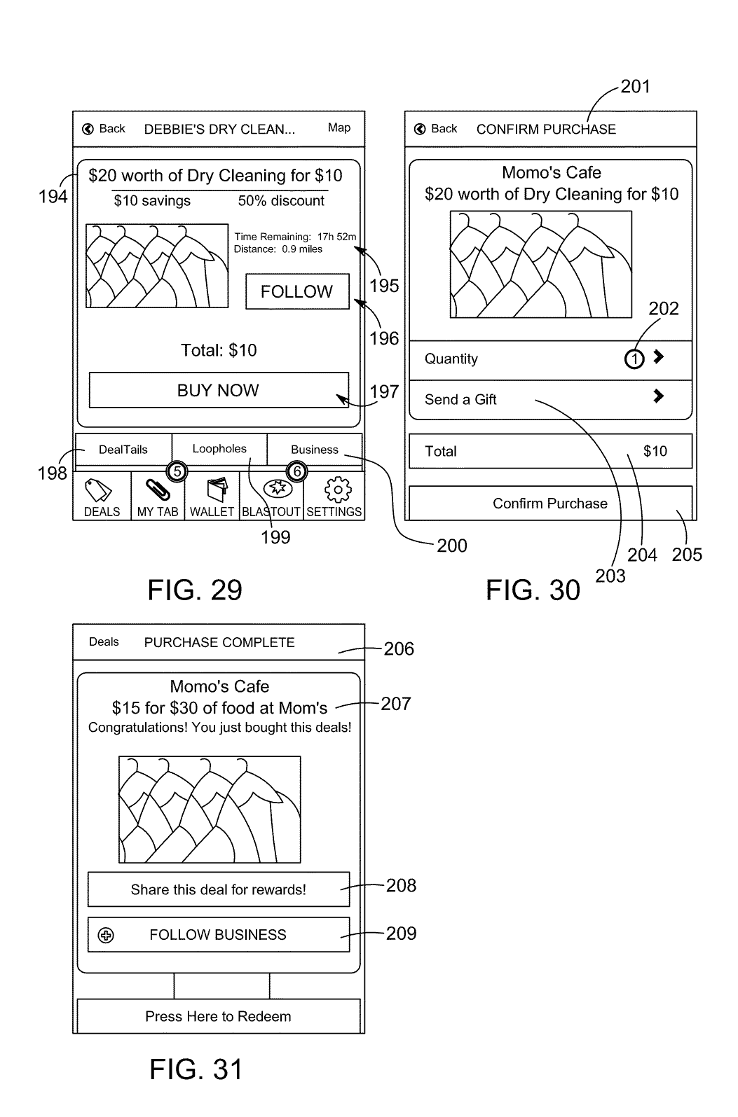

FIGS. 29-31 show exemplary user interfaces for a mobile device depicting a selected deal landing page display with offer restated 194. The user interface may display a selected time and distance re-displayed 195, a follow this merchant activation to add to mytab archive of followed merchants 196, a buy now selection to acquire this offer 197, a deal tails navigational button 198, a loopholes navigational button 199, and a business navigational button 200. Upon selection of the buy-now navigational button 197, the user is directed to a confirm offer purchase landing page 201. Therein the user may, in one embodiment, select a quantity 202, confirm to send as a gift 203, view a total purchase amount to be taken from the virtual wallet system 204, and confirm purchase option 205. Upon selection of the confirm purchase option 205, the user is directed to a purchase complete landing page 206. Therein the user may, in one embodiment, view the coupon just purchased 207, share deal with a social networking system 208, and/or select to follow this business 209.

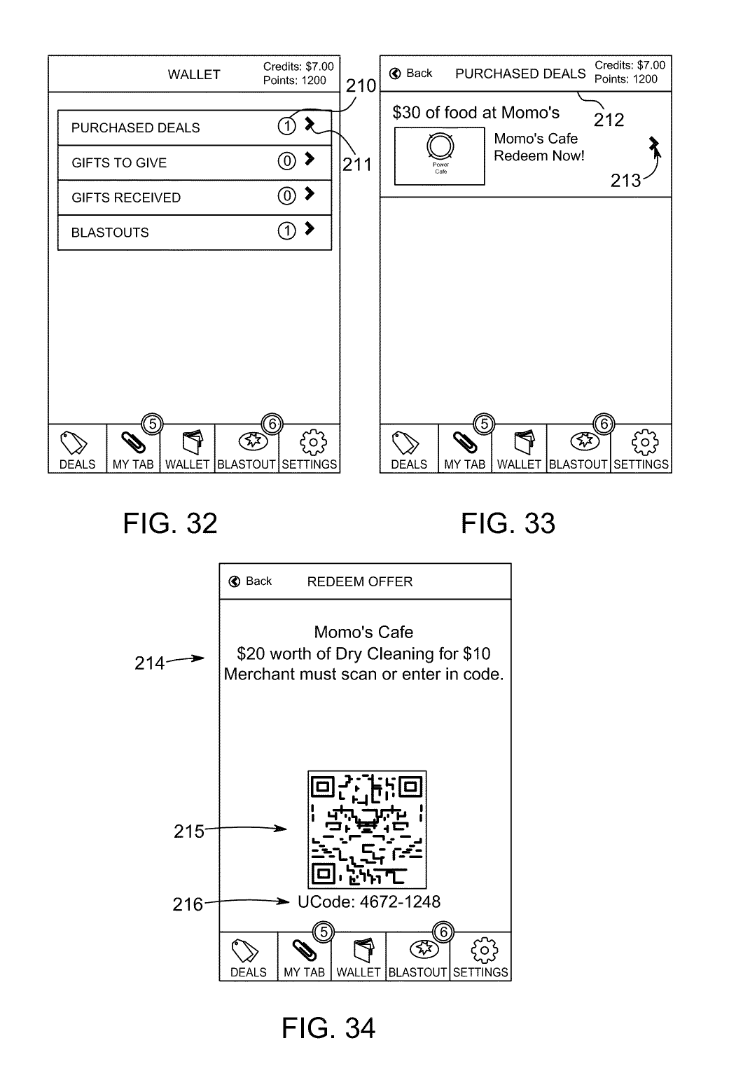

FIGS. 32-34 show exemplary user interfaces for a mobile device depicting a purchase displayed in the virtual wallet. As FIGS. 32-34 show, an indicia may be incorporated into the interface to indicates new deal purchased 210. A navigational button 211 may be included to select to see the purchased deal in the virtual wallet system. Upon selection of the button 211, a user is preferably directed to a purchased deal summary page 212 wherein a user may select a navigational button 213 to redeem deal. Upon selection of the redeem deal navigational button 213, a user is directed to a redeem offer display landing page 214 wherein the user interface displays a scannable code 215, and a proprietary alphanumeric code 216.

FIG. XX shows a flow diagram illustrating an exemplary process 500 of the system 300. At step 502, the system generates a merchant campaign based upon input from a merchant-user. Each merchant-user may generate one or more campaigns. As described herein above, each merchant campaign may include one or more goods or services each associated with one or more terms of an offer for the goods or services such as an offer price, a duration for accepting the offer, an offer location zone, a redemption location, and a duration for redeeming an accepted offer. At step 504, the system receives instructions from a customer-user to subscribe to a merchant campaign.

At step 506, the system receives location-based information indicative of the customer-user's physical location, although the system may monitor the customer-user's physical location at any time through the process. Subsequent to following a merchant campaign, the system transmits the offer to the customer-user when the received location-based information indicative of the customer-user's physical location is within the offer location zone while the customer-user is subscribed to the merchant campaign 508. Once one or more offers are received by the customer-user, the customer-user may select any received offer and transmitted acceptance of the selected offer at step 510. The system receives the acceptance and checks for satisfaction of a predetermined contingency, e.g., payment, transmission of loyalty credits. Upon valid acceptance and satisfaction of the contingency, the system transmits a unique identifier for redemption when the customer-user's physical location is within the offer location zone 512. After physically traveling to the redemption location, or remaining within, at step 514, the consumer-user presents the unique identifier for validation. At step 516, the system validates the unique identifier and fulfills the offer.

By tying operation of the system to geography and location of the consumer-user and offer redemption location, fraud is reduced and consumer-user receive more useful and relevant offers, thereby decreasing risk that potential customers will ignore the discounting offer or future discounting offers.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method for facilitating a merchant-customer retail event, the method comprising:
receiving instructions from a customer-user to subscribe to a merchant campaign, wherein the merchant campaign comprises one or more goods or services each associated with one or more terms of an offer for the goods or services, including an offer price, a duration for accepting the offer, an offer location zone, a redemption location, and a duration for redeeming an accepted offer;
receiving location-based information indicative of the customer-user's physical location;
transmitting the offer to the customer-user when the received location-based information indicative of the customer-user's physical location is within the offer location zone while the customer-user is subscribed to the merchant campaign;
receiving acceptance of the offer by the customer-user;
transmitting, upon satisfaction of a predetermined contingency by the consumer-user, a unique identifier for redemption when the customer-user's physical location is within the offer location zone;
receiving the unique identifier from the user at the redemption location; and
determining if the received unique identifier is valid and received within the duration for redeeming the accepted offer for fulfillment of the offer.

2. The method of claim 1, wherein the zone is defined as a distance from the redemption location.

3. The method of claim 1, wherein the zone is defined, at least in part, by a political boundary.

4. The method of claim 1, wherein the unique identifier is encoded within a two-dimensional scannable matrix.

5. The method of claim 1, wherein the receiving the unique identifier from the user at the redemption location is received via scan of a mobile device screen displaying the unique identifier.

6. The method of claim 1, wherein the transmitting the offer to the customer-user is executed for one or more offers associated with a subscribed merchant campaign by the customer-user for display on a mobile device and wherein the acceptance of the offer is received subsequent to selection by the customer-user from among the one or more offers associated with the subscribed merchant campaigns.

7. The method of claim 1, wherein the terms of an offer further includes a quantity parameter and wherein the acceptance of the offer by the customer-user includes a quantity metric.

8. The method of claim 1, further comprising:
transmitting, in response to a request by a customer-user, one or more coupons associated with a merchant campaign, wherein the coupons are each associated with one or more terms including a discount and a redemption duration.

9. The method of claim 1, wherein the transmitting the offer to the customer-user is initiated by a merchant-user and executed only when the customer-user's physical location is within the offer location zone at a time of the initiation by the merchant-user.

10. The method of claim 1, wherein the predetermined contingency is payment.

11. The method of claim 10, wherein payment may be made, at least in part, using metrics derived based upon purchase history.

12. The method of claim 1, further comprising:
defining system-wide immediate-vicinity zone, wherein the immediate-vicinity zone may be associated with a merchant's physical location; and
transmitting the offer to the customer-user when the received location-based information indicative of the customer-user's physical location is within the immediate-vicinity zone irrespective of whether the customer-user is subscribed to the merchant campaign.

13. A non-transitory computer-readable device comprising processor-executable instructions configured to perform actions comprising:
receiving instructions from a customer-user to subscribe to a merchant campaign, wherein the merchant campaign comprises one or more goods or services each associated with one or more terms of an offer for the goods or services, including an offer price, a duration for accepting the offer, an offer location zone, a redemption location, and a duration for redeeming an accepted offer;
receiving location-based information indicative of the customer-user's physical location;
transmitting the offer to the customer-user when the received location-based information indicative of the customer-user's physical location is within the offer location zone while the customer-user is subscribed to the merchant campaign;
receiving acceptance of the offer by the customer-user;
transmitting, upon satisfaction of a predetermined contingency by the consumer-user, a unique identifier for redemption when the customer-user's physical location is within the offer location zone;
receiving the unique identifier from the user at the redemption location; and
determining if the received unique identifier is valid and received within the duration for redeeming the accepted offer for fulfillment of the offer.

14. The method of claim 13, wherein the receiving the unique identifier from the user at the redemption location is received via scan of a mobile device screen displaying the unique identifier.

15. The method of claim 13, wherein the transmitting the offer to the customer-user is initiated by a merchant-user and executed only when the customer-user's physical location is within the offer location zone at a time of the initiation by the merchant-user.

16. The method of claim 13, further comprising:
transmitting, in response to a request by a customer-user, one or more coupons associated with a merchant campaign, wherein the coupons are each associated with one or more terms including a discount and a redemption duration.

17. The method of claim 13, wherein the zone is defined as a distance from the redemption location, an area, or, at least in part, by a political boundary.

18. The method of claim 13, wherein the unique identifier is encoded within a two-dimensional scannable matrix.

19. The method of claim 13, wherein the transmitting the offer to the customer-user is executed for one or more offers associated with a subscribed merchant campaign by the customer-user for display on a mobile device and wherein the acceptance of the offer is received subsequent to selection by the customer-user from among the one or more offers associated with the subscribed merchant campaigns.

20. The method of claim 13, wherein the terms of an offer further includes a quantity parameter and wherein the acceptance of the offer by the customer-user includes a quantity metric.

21. The method of claim 13, further comprising:
defining system-wide immediate-vicinity zone, wherein the immediate-vicinity zone may be associated with a merchant's physical location; and
transmitting the offer to the customer-user when the received location-based information indicative of the customer-user's physical location is within the immediate-vicinity zone irrespective of whether the customer-user is subscribed to the merchant campaign.

22. A system for facilitating a merchant-customer retail event, the system comprising:
one or more processors;
one or more computer-readable media having stored thereon computer-executable instructions that, when executed by the one or more processors, cause the system to:
define a system-wide immediate-vicinity zone, wherein the immediate-vicinity zone may be associated with a merchant-user's physical location;
receive instructions from a customer-user to subscribe to a merchant campaign, wherein the merchant campaign comprises one or more goods or services each associated with one or more terms of an offer for the goods or services, including an offer price, a duration for accepting the offer, an offer location zone, a redemption location, and a duration for redeeming an accepted offer;
receive location-based information indicative of the customer-user's physical location;
transmit the offer to the customer-user when the received location-based information indicative of the customer-user's physical location is within the offer location zone while the customer-user is subscribed to the merchant campaign;
transmit the offer to the customer-user when the received location-based information indicative of the customer-user's physical location is within the immediate-vicinity zone associated with the merchant-user's physical location, irrespective of whether the customer-user is subscribed to the merchant campaign;
receive acceptance of the offer by the customer-user;
transmit, upon satisfaction of a predetermined contingency by the consumer-user, a unique identifier for redemption when the customer-user's physical location is within the offer location zone;
receive the unique identifier from the user at the redemption location; and
determine if the received unique identifier is valid and received within the duration for redeeming the accepted offer for fulfillment of the offer.
